(19) United States
(12) Patent Application Publication
(10) Pub. No.: US 2009/0187592 A1
(43) Pub. Date: Jul. 23, 2009

(54) WEB DOCUMENT USER EXPERIENCE CHARACTERIZATION METHODS AND SYSTEMS

(76) Inventors: Konstantinos Tsioutsiouliklis, San Jose, CA (US); Marcin M. Kadluczka, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 12/018,661

(22) Filed: Jan. 23, 2008

(51) Int. Cl. G06F 7/00; G06F 17/30

(52) U.S. Cl. 707/104.1; 707/E17.009; 707/E17.119

(57) ABSTRACT

Methods and systems are provided that may be used to characterize in some manner the performance that a user may experience when accessing a web document. An exemplary method may include accessing at least one performance characteristic associated with at least a portion of a computing environment adapted for sharing at least one web document, and establishing user experience information associated with the web document based, at least in part, on the performance characteristic.

### BACKGROUND

1. Field

The subject matter disclosed herein relates to network related data communications and processing, and more particularly to information extraction and information retrieval methods and systems.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available, there is a continuing need for methods and systems that allow for relevant information to be identified and presented in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating certain processes, functions and/or other like resources of an exemplary computing environment including an information integration system having a web document user experience characterizer.

FIG. 2 is a flow diagram illustrating an exemplary method that may, for example, be implemented at least in part using the information integration system of FIG. 1.

FIG. 3 is an illustrative diagram showing portions of a search result display that may be associated with the information integration system of FIG. 1.

FIG. 4 is a block diagram illustrating certain device resources in an exemplary embodiment of a computing environment system that may be operatively adapted to provide a computing environment having an information integration system, for example, as in FIG. 1.

### DETAILED DESCRIPTION

Some exemplary methods and systems are described herein that may be used to establish or otherwise characterize in some manner the performance that a user may experience when accessing a web document. The resulting user experience information may be used or otherwise considered in some manner in at least one other process. By way of example but not limitation, the resulting user experience information may be used in an information extraction engine or other like process to help further classify web documents in some manner with respect to the user, and/or in a search engine or other like process to help further rank or otherwise identify or arrange search results in response to a user's search query.

The Internet is a worldwide system of computer networks and is a public, self-sustaining facility that is accessible to tens of millions of people worldwide. Currently, the most widely used part of the Internet appears to be the World Wide Web, often abbreviated “WWW” or simply referred to as just “the web”. The web may be considered an Internet service organizing information through the use of hypermedia. Here, for example, the HyperText Markup Language (HTML) may be used to specify the contents and format of a web document (e.g., a web page).

Unless specifically stated, a web document may refer to either the source code for a particular web page or the web page itself. A web document may, for example, include embedded references to images, audio, video, other web documents, etc. One common type of reference used to identify and locate resources on the web is a Uniform Resource Locator (URL).

In the context of the web, a user may “browse” for information by following references that may be embedded in each of the documents, for example, using hyperlinks provided via the HyperText Transfer Protocol (HTTP) or other like protocol.

Through the use of the Web, users may have access to millions of pages of information. However, because there is so little organization to the web, at times it may be extremely difficult for users to locate the particular web pages that contain the information that may be of interest to them. To address this problem, a mechanism known as a “search engine” may be employed to index a large number of web pages and provide an interface that may be used to search the indexed information, for example, by entering certain words or phrases to be queried.

The search engine may, for example, be part of an information integration system that may also include a “crawler” or other process that may “crawl” the Internet in some manner to locate web documents. Upon locating a web document, the crawler may store the document's URL, and possibly follow hyperlinks associated with the web document, for example to locate other web documents.

An information integration system may also include an information extraction engine or other like process that may be adapted to extract and/or otherwise index certain information about the web documents that were located by the crawler. Such index information may, for example, be generated based on the contents of an HTML file associated with a web document and may be included in a stored index, for example within a database.

A search engine may allow users to search the database, for example, via a user interface that allows a user to input or otherwise specify search query terms (e.g., keywords or other like criteria) and receive and view search results. A search engine may, for example, present search result summaries in a particular order as may be indicated by a ranking function or other like process. A search result summary may, for example, include information about a web document such as a title, an abstract, a link, and/or possibly one or more other related objects that may assist a user in deciding whether to access the web document.

Should a user decide to access a web document based on the search result summary, then the user may, through the user interface, indicate such desire by initiating access to the web document. For example, a user may click-on on link or other like selectable mechanism within a search result summary to initiate access to the web document through a browser or other like process that may be used to access and render web documents. The user interface may, for example, itself be a web document that is accessed and rendered through the browser or other like process.

With so many websites and web pages being available and with varying hardware and software configurations, it may be beneficial to identify which web documents may lead to a desired user experience and which may not lead to a desired user experience. By way of example but not limitation, in certain situations it may be beneficial to determine (e.g., classify, rank, characterize) which web documents may not meet performance or other user experience expectations if selected by the user. Such performance may, for example, be affected by server, network, client, file, and/or like processes and/or the software, firmware, and/or hardware resources associated therewith. Once web documents are identified in this manner the resulting user experience information may, for example, be considered when generating the search results.

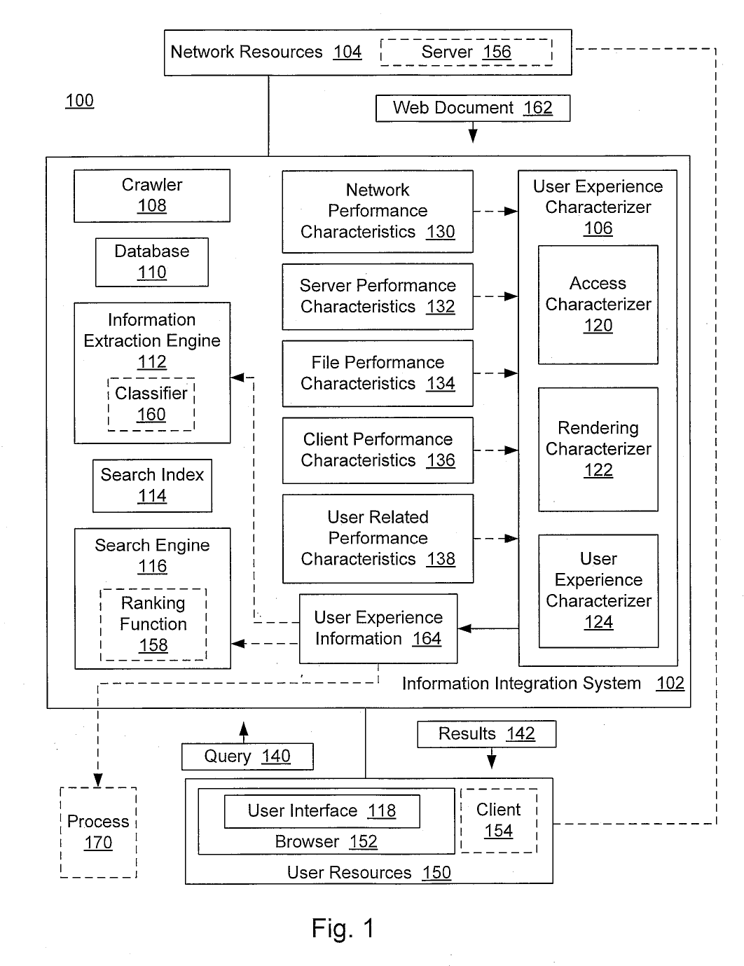

Attention is now drawn to FIG. 1, which is a block diagram illustrating certain processes associated with an exemplary computing environment 100 having an Information Integration System (IIS) 102. The context in which such an IIS may be implemented may vary. For non-limiting examples, an IIS such as IIS 102 may be implemented for public or private search engines, job portals, shopping search sites, travel search sites, RSS (Really Simple Syndication) based applications and sites, and the like. In certain implementations, IIS 102 may be implemented in the context of a World Wide Web (WWW) search system, for purposes of an example. In certain implementations, IIS 102 may be implemented in the context of private enterprise networks (e.g., intranets), as well as the public network of networks (i.e., the Internet).

As illustrated in FIG. 1, IIS 102 may be operatively coupled to network resources 104 and user resources 150. IIS 102 may include a crawler 108 that may access network resources 104, which may include, for example, the Internet and the World Wide Web (WWW), one or more servers, etc. IIS 102 may include a database 110, an information extraction engine 112, a search engine 116 backed, for example, by a search index 114 and possibly associated with a user interface 118 through which a query 140 may be initiated and results 142 provided to the user. Here, for example, user interface 118 may be provided within a browser or other like process of user resources 150. In certain implementations user resources 150 may, for example, include a client 154 or other like process adapted to operatively couple to a server 156 or other like process of network resources 104.

Crawler 108 may be adapted to locate web documents such as, for example, web pages associated with websites, etc. Crawler 108 may also follow one or more hyperlinks associated with a web document to locate other web documents. Upon locating a web document, crawler 108 may, for example, store the web document's URL and/or other information in database 110. Crawler 108 may, for example, store all or part of a web document (e.g., HTML, XML, object, and/or the like) and/or a URL or other like link information in database 110.

Information extraction engine 112 may generate at least one search index 114 based on the information in database 110. Information extraction engine 112 may, for example, be adapted to extract or otherwise identify specific type(s) of information and/or content in web documents, such as, for example, job titles, job locations, experience required, etc., using a classifier 160 or other like process. Search index 114 may, for example, be accessed by search engine 116 during a search based on query 140. In certain implementations, at least a portion of search index 114 may be included in database 110.

IIS 102 may also include or otherwise be operatively coupled to a user experience characterizer 106. As shown user experience characterizer 106 may, for example, include processes such as an access characterizer 120, a rendering characterizer 122, and/or a user experience characterizer 124. User experience classifier 106 may also include or otherwise access certain network performance characteristics 130, server performance characteristics 132, file performance characteristics 134, client performance characteristics 136, and/or user related performance characteristics 138. User experience characterizer 106 may, for example, generate user experience information 164. As illustrated, by way of example but not limitation, user experience information 164 may be accessed or otherwise used by information extraction engine 112, search engine 116, and/or other like process within IIS 102 and/or possibly at least one process 170 that may be outside of IIS 102.

Access characterizer 120 may, for example, be adapted to characterize the “accessibility” of web document 162 as may be experienced by a user of computing environment 100. For example, access characterizer 120 may be adapted to establish (e.g., measure, determine, and/or otherwise estimate) certain performance characteristics that may be experienced by a user upon initiating access to web document 162. Such performance characteristics may include, for example, potential latency characteristics associated with the various network hardware and software resources that may operatively couple client 154 and server 156 together to transfer one or more data files associated with web document 162. Thus, in certain exemplary implementations, access characterizer 120 may take into consideration applicable network performance characteristics 130, server performance characteristics 132, file performance characteristics 134, and/or other applicable performance characteristics as needed to characterize such web document accessibility performance.

Web document accessibility performance may vary from one user (e.g., client) to another and/or one website or web page (e.g., data file, server) to another as different hardware and/or software resources may be involved. For example, some users may be able to access a data file faster than others as a result of having a higher speed data connection (e.g., broadband versus dial-up modem, etc.). For example, some servers may provide for faster downloading of data files due to higher bandwidth connections, replication, strategic locations, etc. For example, some web documents may be smaller in size (data) and therefore faster to access than other larger sized (data) web documents.

In certain exemplary implementations, crawler 108 or other like process may be adapted to establish network performance characteristics 130, server performance characteristics 132, file performance characteristics 134, and/or other applicable performance characteristics as needed to characterize such web document accessibility performance. Thus, for example, network performance characteristics 130 server performance characteristics 132, file performance characteristics 134, and/or other applicable performance characteristics as needed to characterize such web document accessibility performance may be established (e.g., measured, determined, and/or otherwise estimated) by crawler 108 while locating and/or accessing a web document. Here, for example, crawler 108 may be adapted to simulate, emulate or otherwise take into consideration different communication capabilities as might be applicable to one or more specific users and/or certain types of users, clients, user resources, etc.

Rendering characterizer 122 may be adapted to characterize a rendering and/or presentation capability for web document 162 within computing environment 100. For example, rendering characterizer 122 may be adapted to establish (e.g., measure, determine, and/or otherwise estimate) certain performance characteristics that may be experienced by a user upon accessing one or more data files associated with web document 162. Such performance characteristics may include, for example, potential latency characteristics associated with the browser or other like software and hardware client resources that may be adapted to “render” the web document. Such rendering may, for example, include displaying visual information, reproducing audio or video information, presenting objects, presenting interactive user input/output features, providing additional data access or communication features, and/or the like as may be operatively associated with a web document. In certain exemplary implementations, for example, access characterizer 120 may take into consideration applicable file performance characteristics 134, client performance characteristics 136, and/or other applicable performance characteristics as needed to characterize such web document rendering performance.

Web document rendering performance may vary from one user (e.g., client) to another and/or one web document to another as different hardware and/or software resources may be involved. For example, some user resources may have fast hardware and/or different software configurations that may be able to render or otherwise process the accessed data file(s) faster than others. For example, some web documents may be rendered or otherwise processed faster than others due to differences in complexity, size, number of files, user interface mechanisms, embedded sections (e.g., advertisements, audio content, video content, security features, etc), and/or the like.

In certain exemplary implementations, crawler 108, search engine 116 or other like process may be adapted to establish file performance characteristics 134, client performance characteristics 136, and/or other applicable performance characteristics as needed to characterize such web document rendering performance. Thus, for example, file performance characteristics 134, client performance characteristics 136, and/or other applicable performance characteristics as needed to characterize such web document rendering performance may be established (e.g., measured, determined, and/or otherwise estimated) by crawler 108 while locating and/or accessing a web document. Here, for example, crawler 108 may be adapted to simulate, emulate or otherwise take into consideration different rendering capabilities as might be applicable to one or more specific users and/or certain types of users, clients, user resources, etc. Thus, in certain implementations, all or portions of a web document may be rendered by crawler 108 in some manner to establish such web document rendering performance as might subsequently be experienced by a user.

User experience characterizer 124 may be adapted to characterize certain user experiences (e.g., acceptable performance levels, interactivity, etc.) associated with the access, presentation, and/or use of a website or web page by a user. For example, user experience characterizer 124 may be adapted to receive, access, and/or establish (e.g., measure, determine, and/or otherwise estimate) certain performance characteristics that may be acceptable or otherwise perceived to be desirable (or unacceptable or otherwise perceived to be undesirable) to a user. Such performance characteristics may include, for example, acceptable user latency threshold characteristics, and/or perceived desired (or undesired) user interactive or other like web pages and/or web page features. Thus, in certain exemplary implementations, user experience characterizer 124 may take into consideration applicable file performance characteristics 134, user related performance characteristics 138, and/or other applicable performance characteristics as needed to characterize such user related performance associated with a web document.

The user related performance may vary from one user to another and/or for a user from one web document to another, for example, due to inherent differences. For example, certain users may have more patience than others and as such may accept longer access or rendering delays. For example, certain users may have more patience for such delays as might be experienced for certain web documents. Here, for example, a user may be more likely to wait for a web document associated with their bank account to be accessed and rendered than they might be for a more generic or non-specific web document.

In certain exemplary implementations, search engine 116, user interface 118, and/or the like may be adapted to determine user related performance characteristics 138. For example, certain user related performance characteristics may be selectively input by the user through user interface 118, browser 152, etc. Thus, a user may specify in advance certain performance desires. In certain implementations, for example, one or more user related performance characteristics 138 may be identified over time as the user accesses or attempts to access web documents or otherwise uses interacts with the user resources in some manner. For example, a user may demonstrate an inherent or apparent dislike, e.g., through their previous interactions, for web documents that fail to download or to be rendered in some way within an acceptable period of time. A user may, for example, specify or demonstrate through previous actions that web documents that automatically play video or audio content, include pop-up or pop-under advertisements, and/or in some other manner initiate further delays due to additional file downloading, additional processing, etc., may not be desired.

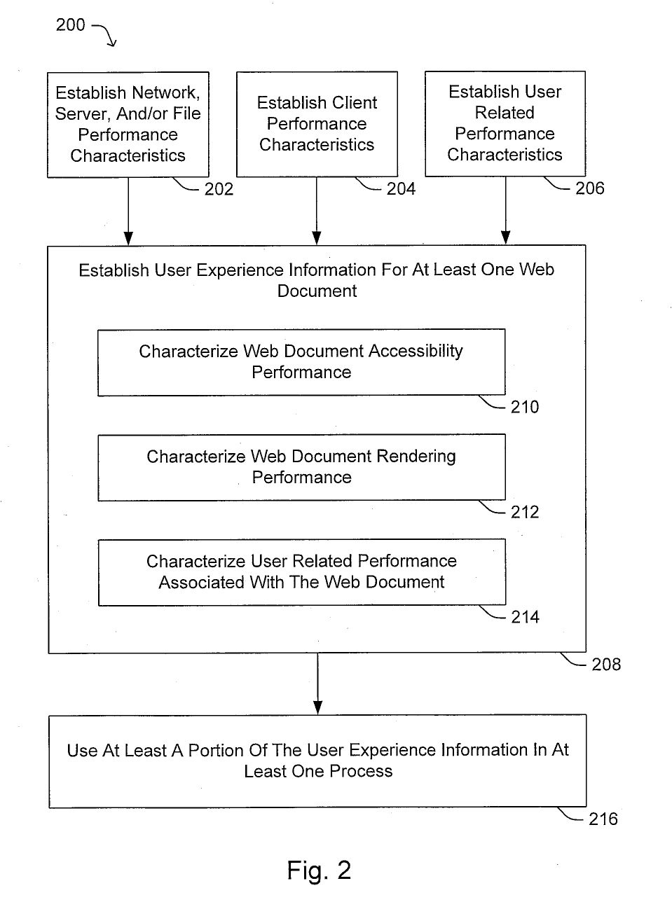

All or portions of exemplary method 200 as shown in FIG. 2 may be implemented in computing environment 100 of FIG. 1 and/or computing environment system 400 of FIG. 4. At block 202 network performance characteristics, server performance characteristics, and/or file performance characteristics may be established, at block 204 client performance characteristics may be established, and at block 206 user related performance characteristics may be established.

At block 208 user experience information may be established, for example, for at least one web document based one at least a portion of the performance characteristics from at least one of blocks 202, 204, and/or 206. By way of example, block 208 may include one or more of blocks 210, 212, and 214. At block 210, for example, a web document's accessibility performance may be characterized. At block 212, for example, a web document's rendering performance may be characterized. At block 214, for example, user related performance associated with the web document may be characterized.

At block 216, the user experience information resulting from block 208 may be used in some manner by at least one process. By way of example but not limitation, the user experience information may be used by a search engine as an input to a ranking function to help identify search results and/or otherwise establish an order for search results associated with a query. By way of example but not limitation, the user experience information may be used by an information extraction engine as an input to a classifier to help classify a web document in a search index.

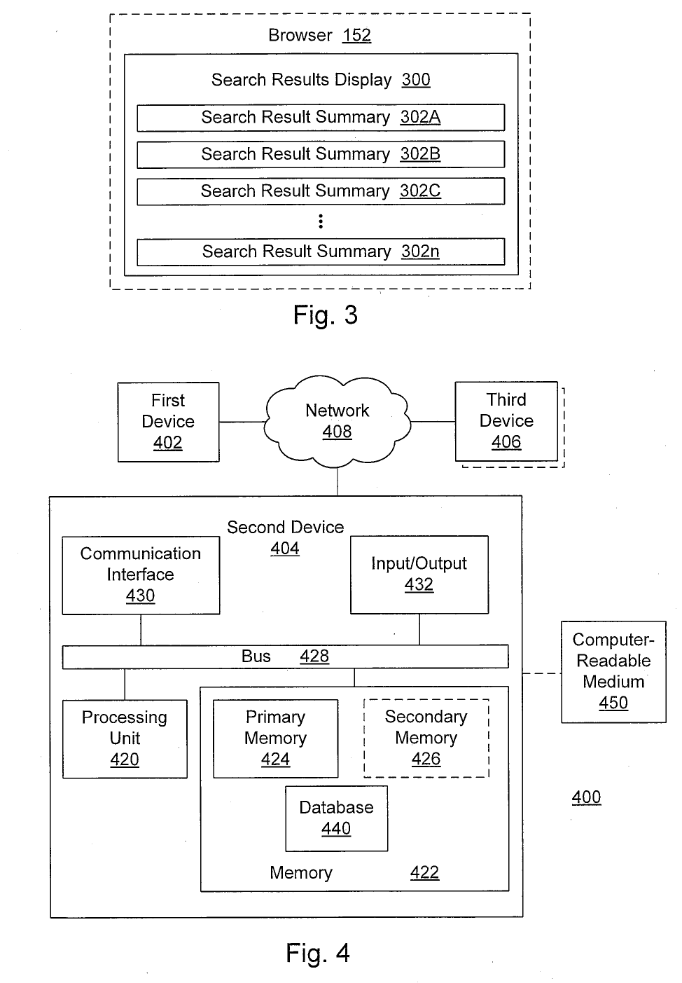

FIG. 3 is an illustrative diagram showing an exemplary search results display 300, for example, as might be shown to a user through a browser 152 or other like process. Search results summary display 300 may include a plurality of search result summaries 302 associated with a query. Here, for example, search result summaries 302A, 302B, 302C, and through 302n are shown. This ordering may be affected by user experience information 164 (FIG. 1) and/or of block 208 (FIG. 2). For example, search result summary 302C may have been adjusted down to the third position by the search engine as a result of a change in classification and/or ranking based on user experience information characterization that suggests search result summaries 302A and 302B may be perceived as better suited for a user.

The user may select (e.g., via browser 152) one of search result summaries or a link portion thereof to initiate access to the corresponding web document. However, if the applicable data file(s) download and/or render too slowly the user's experience may be unacceptable and may result in the user abandoning his/her attempted access or possibly the entire session with the search engine.

Search engines may, for example, include ranking functions that focus on improving the “quality” or “relevance” of search result summaries for a given query. With the exemplary methods and systems provided herein, a quality or relevance determination may (also) take into consideration the desired, potential, and/or otherwise established user experience, for example, as one or more parameters in ranking or displaying search result summaries.

The user experience information of block 208 in FIG. 2, for example, may allow a search engine or other like process to consider several characteristics relating to one or more of the network, server, client, file, or user, and of which one or more may affect the accessibility, rendering, or user experience with a web document, search engine or other like process or service.

All or a portion of the network, server, and file performance characteristics at block 202 may, for example, be established by a crawler or other like process as the web document is processed. Here, for example, a crawler or other like process may establish certain performance characteristics by accessing the web document. Thus, for example, in certain exemplary implementations, latency characteristics associated with the network, server, and/or file may be established by a crawler or other like process as might be experienced by a user when accessing the web document.

All or a portion of the client performance characteristics at block 204 may, for example, be established by a crawler or other like process as the web document is processed. Here, for example, a crawler or other like process may establish certain performance characteristics by accessing the website or web page as might a client resource. Thus, for example, in certain exemplary implementations, latency characteristics associated with client resources (e.g., applicable hardware, software, communication, etc.) may be established by a crawler or other like process using, simulating, or otherwise estimating in some manner at least a portion of the latency that a user may experience when accessing a web document.

Some exemplary latency characteristics may, for example, include latency associated with establishing a connection between a client and a server. Such latency may include the time period from when a browser attempts to connect to the server to the moment the connection is fully established. A crawler or other like process may, for example, establish such latency characteristic by simulating a browser. Since there may be several different types of browsers, the crawler or other like process may be adapted to simulate several of different browsers to generate corresponding latency characteristics. The crawler or other like process may, for example, be adapted to take into account certain error and status messages that occur when accessing or attempting to access web documents when establishing such latency characteristics.

Some exemplary latency characteristics may, for example, include latency beginning with receipt of the first packet of data and the first rendered display of a web document. For example, in certain implementations, after about 8 KB of data have been received a browser may attempt to render and display at least a portion of a web page. In many cases this initial amount of data may not be enough to display the entire page, but may be enough to display a significant portion thereof so as to affect a user's experience.

Some exemplary latency characteristics may include latency associated with subsequent re-rendering and/or reloading of all or part of a web document. For example, in certain situations, after the initial rendering of a web page, and while the web page has not been fully received, a browser may repeat follow-up renderings every time a new portion of data (e.g., about 8 KB of data) is received, and/or if more than a certain amount of time has lapsed since last refreshing the displayed web page. Here, the number of re-renderings or re-loads, the time intervals between such, and/or how the web page that is being displayed is re-arranged or shuffled as a result may affect the user's experience.

Some exemplary latency characteristics may include latency associated with the time to fully display a web document. For example, such latency characteristics may be associated with the time to fully receive the applicable data file(s) and/or the time to receive enough data to display at least a visible web page (e.g., from the top of the page to the fold). The crawler or other like process may, for example, take into account certain error and status messages, time-outs, dropped connections, and other useful information that may occur when accessing or attempting to access web documents, for example, when acting as might a browser or other like process.

In certain exemplary implementations, some latency characteristics may also take into consideration latency associated with native, embedded and/or external objects that may be associated with a web document. For example, some web pages may include JavaScript, Flash, and/or other like embedded or externally linked objects and/or plug-ins. Thus, the number, type, and/or size of such objects may significantly affect accessibility and/or rendering latencies.

In certain exemplary implementations, the resulting user experience information may be used in a ranking function, a classifier or other like process adapted to filter, promote/demote, etc, web documents in some manner to possibly support a desired user experience.

In certain exemplary implementations, the resulting user experience information may be used in a classifier or other like process, for example, to help classify a web document in some manner. For example, the layout of a web document may be indicative of a certain content type. For example, finance-related websites often display streaming data of the stock market, news websites also often stream content, and certain types of web pages might use frames or tables which may be useful in classifying the web document.

In certain exemplary implementations, the resulting user experience information may be used to take into consideration user behavior, for example, as a guide for subsequent crawling and/or indexing processes. For example, information relating to whether a user might abandon or wait for a web document to be displayed may be useful when establishing certain quality or relevance factors for the web document. For example, information relating to whether a user might wait for or specifically request embedded or external objects to be downloaded and displayed may be useful when establishing certain quality or relevance factors for the web document. In certain implementations such information may, for example, be used to determine if a crawler or other like process should also execute such embedded and/or external objects to establish performance parameters, etc.

In certain exemplary implementations, some latency characteristics may be established by processes running on a client resource, for example, as part of a browser or other like process. Some latency characteristics may be provided by other network resources, such as, for example, servers, network providers, service providers, affiliated services, equipment manufactures, software developers, statistical modeling and/or analysis, user studies, etc.

In certain exemplary implementations, an overall latency characteristic may be established that takes into consideration at least an estimated speed of the connecting network, server(s) transmitting the data files, and time to render a web document as might be experienced by a user.

Reference is now made to FIG. 4, which is a block diagram illustrating an exemplary embodiment of a computing environment system 400 that may be operatively adapted and/or otherwise associated with computing environment 100 of FIG. 1. Computing environment system 400 may include, for example, a first device 402, a second device 404 and a third device 406, which may be operatively coupled together through a network 408.

First device 402, second device 404 and third device 406, as shown in FIG. 4, are each representative of any device, appliance or machine that may be configurable to exchange data over network 408. By way of example but not limitation, any of first device 402, second device 404, or third device 406 may include one or more computing devices or platforms, such as, e.g., a desktop computer, a laptop computer, a workstation, a server device, a client device, storage units, or the like.

Network 408, as shown in FIG. 4, is representative of one or more communication links, processes, and/or resources configurable to support the exchange of data between at least two of first device 402, second device 404 and third device 406. By way of example but not limitation, network 408 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 406, there may be additional like devices operatively coupled to network 408.

It is recognized that all or part of the various devices and networks shown in system 400, and the processes and methods as further described herein, may be implemented using or otherwise include hardware, firmware, software, or any combination thereof.

By way of example but not limitation, second device 404 may include at least one processing unit 420 that is operatively coupled to a memory 422 through a bus 428. Processing unit 420 is representative of one or more circuits configurable to perform at least a portion of a data computing procedure or process. By way of example but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 is representative of any data storage mechanism. Memory 422 may include, for example, a primary memory 424 and/or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420. Secondary memory 426 may include, for example, the same or similar type of memory as primary memory and/or one or more data storage devices or systems, such as, for example, a disk drive, an optical disc drive, a tape drive, a solid state memory drive, etc.

In certain implementations, secondary memory 426 may be operatively receptive of, or otherwise configurable to couple to, a computer-readable medium 450. Computer-readable medium 450 may include, for example, any medium that can carry and/or make accessible data, code and/or instructions for one or more of the devices in system 400. Additionally, as illustrated in FIG. 4, memory 422 may include a data associated with a database 440. Such data may, for example, be stored in primary memory 424 and/or secondary memory 426.

Second device 404 may include, for example, a communication interface 430 that provides for or otherwise supports the operative coupling of second device 404 to at least network 408. By way of example but not limitation, communication interface 430 may include a network interface device or card, a modem, a router, a switch, a transceiver, and the like.

Second device 404 may include, for example, an input/output 432. Input/output 432 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 432 may include an operatively adapted display, speaker, keyboard, mouse, trackball, touch screen, data port, etc.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising
accessing at least one performance characteristic associated with at least a portion of a computing environment adapted for sharing at least one web document;
establishing user experience information associated with said at least one web document based, at least in part, on said at least one performance characteristic; and
using at least a portion of said user experience information in at least one process within said computing environment.

2. The method as recited in claim 1, wherein said at least one process comprises at least one process selected from a group of computer processes comprising a crawler process, an information extraction process, a search engine process, a ranking function process, a server process, a client process, a user interface process, and a browser process.

3. The method as recited in claim 1, wherein said portion of said computing environment comprises at least one resource selected from a group of resources comprising at least a portion of a network, a computing device, a server process, a client process, a browser process, and at least one data file associated with said web document.

4. The method as recited in claim 1, further comprising establishing said at least one performance characteristic.

5. The method as recited in claim 1, further comprising establishing said at least one performance characteristic using at least one process associated with an information integration system.

6. The method as recited in claim 1, further comprising establishing said user experience information using at least one process associated with an information integration system.

7. The method as recited in claim 1, wherein establishing said user experience information comprises establishing access latency information associated with said web document.

8. The method as recited in claim 7, wherein establishing said access latency information comprises establishing expected latency between access initiation and receipt of said web document.

9. The method as recited in claim 8, wherein said access initiation and said receipt of said web document are associated with a browser process.

10. The method as recited in claim 1, wherein establishing said user experience information comprises establishing rendering latency information associated with said web document.

11. The method as recited in claim 10, wherein establishing said rendering latency information comprises establishing an expected latency between an initial rendering and a full rendering of said web document.

12. The method as recited in claim 11, wherein said initial rendering and said full rendering of said web document are associated with a browser process.

13. The method as recited in claim 1, wherein establishing said user experience information comprises establishing user related latency information associated with said web document.

14. The method as recited in claim 13, wherein establishing said user related latency information comprises establishing a user acceptable latency between access initiation and at least a partial rendering of said web document.

15. The method as recited in claim 14, wherein said access initiation and said at least a partial rendering of said web document are associated with a browser process.

16. A system comprising at least one processing unit adapted to access at least one performance characteristic associated with at least a portion of a computing environment adapted for sharing at least one web document, establish user experience information associated with said at least one web document based, at least in part, on said at least one performance characteristic, and use at least a portion of said user experience information in at least one process within said computing environment.

17. The system as recited in claim 16, wherein said at least one process comprises at least one process selected from a group of computer processes comprising a crawler process, an information extraction process, a search engine process, a ranking function process, a server process, a client process, a user interface process, and a browser process, and wherein said portion of said computing environment comprises at least one resource selected from a group of resources comprising at least a portion of a network, a computing device, a server process, a client process, a browser process, and at least one data file associated with said web document.

18. The system as recited in claim 16, wherein said at least one processing unit is further adapted to establish said at least one performance characteristic.

19. The system as recited in claim 16, wherein said at least one performance characteristic comprises latency information associated with accessing and/or rendering said web document.

20. A computer program product, comprising computer-readable medium comprising instructions for causing at least one processing unit to:
establish at least one performance characteristic associated with at least a portion of a computing environment adapted for sharing at least one web document; and
establish user experience information associated with said at least one web document based, at least in part, on said at least one performance characteristic.
